(19) United States
(12) Patent Application Publication
(10) Pub. No.: US 2006/0131865 A1
(43) Pub. Date: Jun. 22, 2006

(54) Steering assembly and method of operating the same

(76) Inventors: Gregory A. Wasek, Shelby Township, MI (US); Sean A. Bannon, Bloomfield Hills, MI (US); Travis D. Bechtel, Goodrich, MI (US); Richard J. Brettfeld, Chandler, AZ (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/022,433

(22) Filed: Dec. 22, 2004

(51) Int. Cl. B62D 1/18

(52) U.S. Cl. 280/775; 280/777; 74/493

(57) ABSTRACT

A steering assembly and a method of operating the same. The assembly includes a steering column and a steering component operably attached to the steering column. The steering component includes at least one range of motion. The steering component is operably attached to a shaft. At least one gas spring is operably attached to the steering assembly. The at least one gas spring mediates the at least one range of motion. The method includes providing a steering column. A steering component operably attached to the steering column is provided. A steering component operably attached to a shaft is provided. At least one range of motion of the steering component is provided. A gas pressure is modulated while providing at least one range of motion.

### TECHNICAL FIELD OF THE INVENTION

The present invention relates generally to steering assemblies for vehicles. More particularly, the invention relates to gas spring steering assemblies and method of operating the same.

### BACKGROUND OF THE INVENTION

A vehicle (e.g., an automobile, minivan, truck, etc.) may be steered by rotating a steering component, such as a steering wheel, positioned adjacent to a driver. The steering component may be operably attached at an upper end portion of a steering column so as to be rotatable about an axis. Rotation of the steering component is coupled to the steering of the vehicle's tires (the front tires and, optionally, the rear tires).

The steering column may be positioned in an upward orientation. The steering column may extend out of the interior of the vehicle via an intermediate transmittance shaft such as a universal joint or the like, which may be connected to a steering mechanism. The steering mechanism may include a movement transforming unit, such as a rack-and-pinion, a ball thread or the like. As such, the rotating motion of the steering wheel is transmitted via the steering column and the intermediate transmittance shaft to the steering mechanism where it is transformed into movement for turning the tire wheels via the movement transforming unit.

Many contemporary steering assemblies allow positioning of the steering wheel at an upper end of the steering column thereby optimizing comfortable steering operation. In general, the position of the steering wheel may be adjusted with a combination of tilt adjustment for adjusting a tilt angle and a telescopic positioning of the steering component with respect to the steering column. Such tilt-telescope steering assemblies are well known in the art, but typically include a large number of parts. Some of the parts provide a tilt lock and some provide a lock of the telescoping positioning. However, reducing the number of parts has been a problem.

For example, tilt steering assemblies may include a locking mechanism that maintains the steering component in its selected tilt position. Known locking mechanisms include pawl-and-rack and rotary actuated designs. Known pawl-and-rack designs tend to be relatively complex and have difficulty in maintaining the steering component in its selected position when considerable force is applied to the steering component in a direction that is highly skewed to the axis of the steering component.

The rotary actuated designs appear to be relatively less complex, but in practice must contend with issues relating to vibration of the steering column and steering component as a result of the lash within these mechanisms. Attempts to minimize lash to thereby attenuate the vibration of the steering component typically utilize highly toleranced components and the matching of components to minimize lash. As such, these mechanisms tend to be relatively expensive to manufacture and service. Therefore, it would be desirable to provide a tilt-telescope steering assembly including a minimal number of parts yet is relatively inexpensive.

Many contemporary steering assemblies also include an energy absorbing mechanism for lessening impact energy of a driver with the steering column in the event of a crash. In general, the energy absorbing mechanism may include an elastic member positioned at a middle portion of the steering column. Force transmitted along an axial direction of the steering component and steering column is dampened by the energy absorbing mechanism. As such, the severity of the impact of the driver with the steering assembly is reduced. Therefore, it is desirable for a steering assembly to include an energy absorbing mechanism.

Therefore, it would be desirable to provide a gas spring steering column and method of operating the same that overcomes the aforementioned and other disadvantages.

### SUMMARY OF THE INVENTION

One aspect of the present invention provides a steering assembly. The assembly includes a steering column and a steering component operably attached to the steering column. The steering component includes at least one range of motion. The steering component is operably attached to a shaft. At least one gas spring is operably attached to the steering assembly. The at least one gas spring mediates the at least one range of motion.

Another aspect of the invention provides a method of operating a steering column. The method includes providing a steering column. A steering component operably attached to the steering column is provided. A steering component operably attached to a shaft is provided. At least one range of motion of the steering component is provided. A gas pressure is modulated while providing at least one range of motion.

Another aspect of the invention provides a steering assembly. The assembly includes a steering column and a steering component operably attached to the steering column. The steering component is operably attached to a shaft. The assembly includes means for providing at least one range of motion of the steering component, and means for modulating a gas pressure while providing at least one range of motion.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIGS. 1A, 1B, and 1C are schematic views of a steering assembly in accordance with one embodiment of the present invention wherein the assembly is shown in various tilt and telescoping positions;

FIG. 2 is a detailed schematic view of a gas spring shown in FIGS. 1A, 1B, and 1C; and

FIG. 3 is a schematic view of the steering assembly of FIG. 1 shown operably attached to a vehicle in accordance with one embodiment of the present invention.

### DETAILED DESCRIPTION OF THE PRESENTLY PREFERRED EMBODIMENTS

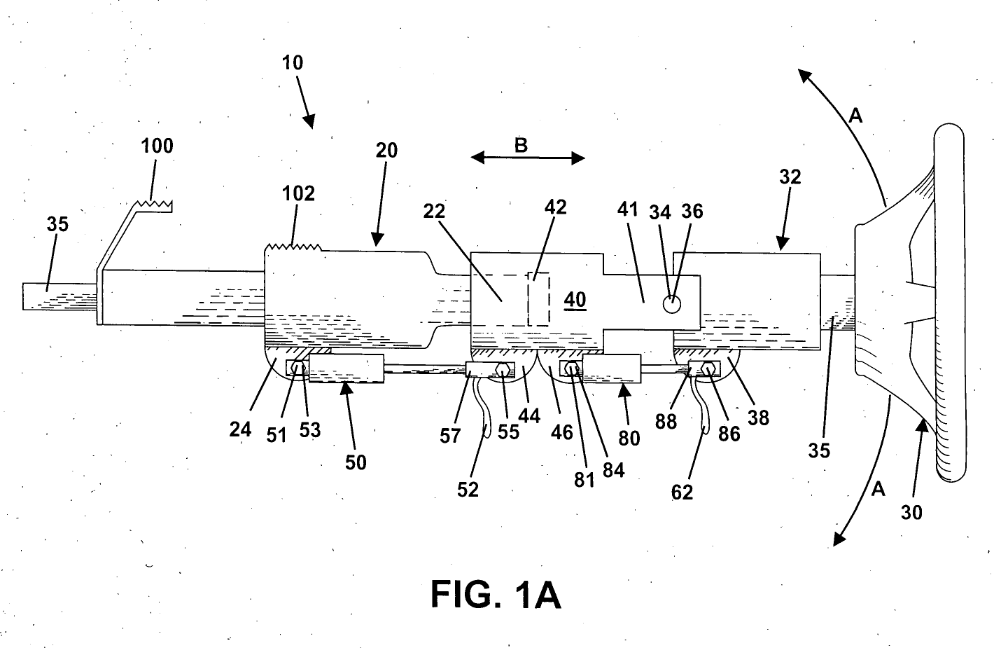

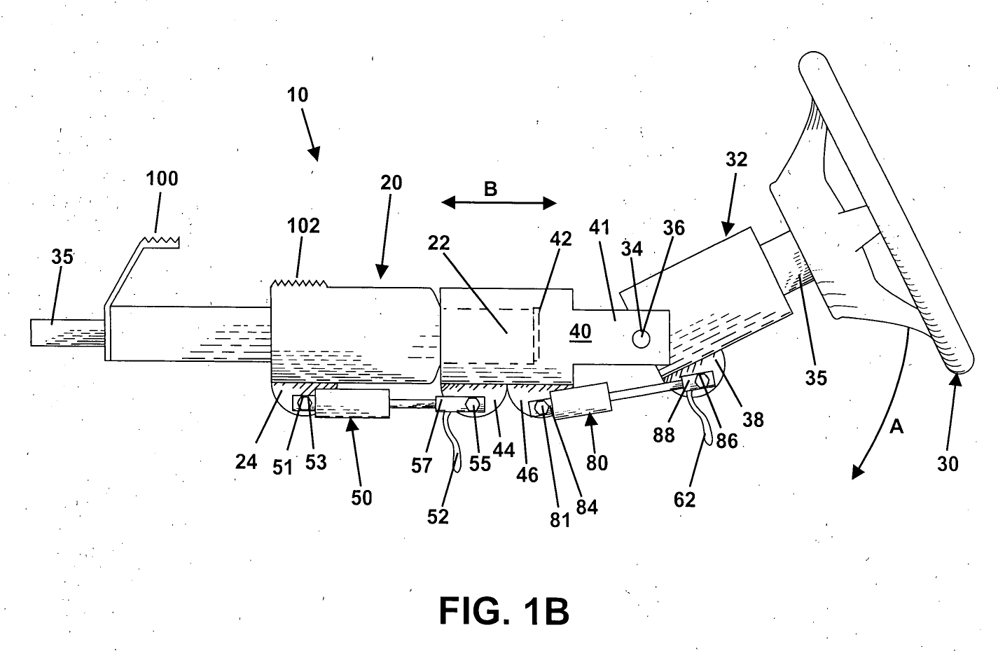

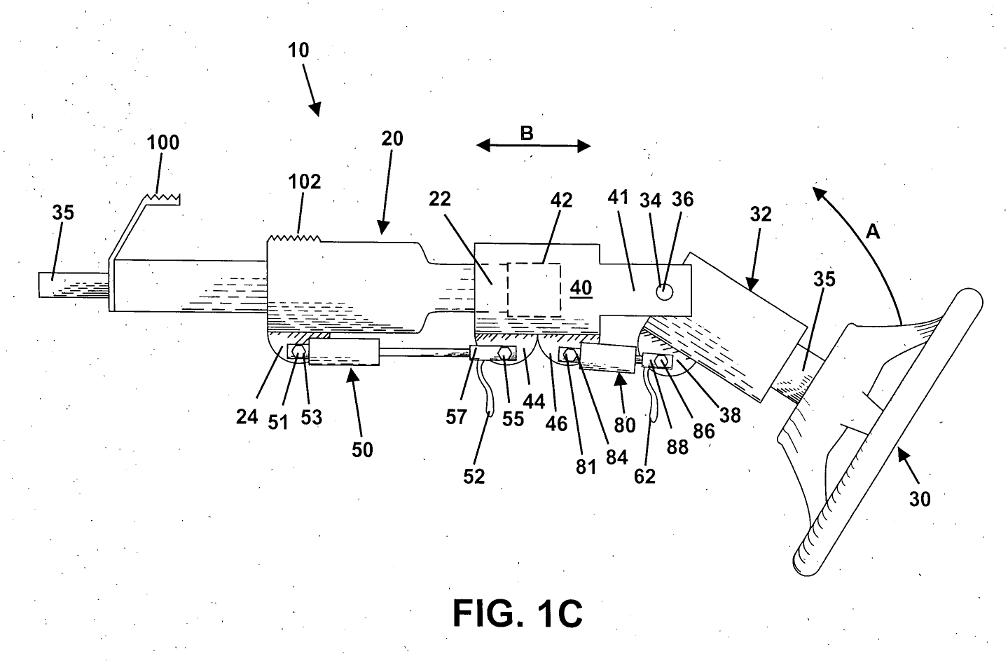

Referring to the drawings, wherein like reference numerals refer to like elements, FIGS. 1A, 1B, and 1C are schematic views of a steering assembly, shown generally by numeral 10, in accordance with one embodiment of the present invention. Assembly 10 includes a steering column 20 and a steering component 30, in this case a steering wheel, operably attached to the steering column 20. Steering component 30 includes at least one, and in this case two, ranges of motion. Steering component 30 is operably attached to a shaft 35. At least one, and in this case two, gas springs 50, 80 are operably attached to the assembly 10. Gas springs 50, 80 each mediate a range of motion of the assembly 10, as described below. Those skilled in the art will recognize that the configuration of the assembly 10 may vary from the present description and figures. The Inventors contemplate that numerous variations may be made to the assembly 10 without departing from the spirit and scope of the claims.

In one embodiment, a first range of motion of the assembly 10 includes a tilt movement, as shown along arrows A, and a second of motion of the assembly 10 includes a telescoping movement, as shown along arrows B. FIGS. 1A, 1B, and 1C illustrate the ranges of motion with a plurality of tilt and telescoping positions achievable therebetween. FIG. 1A illustrates the steering component 30 in the mid-tilt and mid-telescope positions. FIG. 1B illustrates the steering component 30 in the fully up-tilt and fully retracted positions. FIG. 1C illustrates the steering component 30 in the fully down-tilt and fully extended and the positions. Those skilled in the art will recognize that additional or fewer ranges of motions of the assembly 10 may be provided.

In one embodiment, to provide the tilt movement, the steering component 30 may be operably attached to the steering column 20 with a steering column tilt assembly 32.

Steering column tilt assembly 32 may include a bolt (or other fastening means) positioned through an aperture 34, which is formed within a tilt head 36 portion of the steering component 30 and two flanking flange portions 41 of a telescoping assembly 40. To facilitate the telescoping movement, the steering component 30 may be operably attached to the steering column 20 with the telescoping assembly 40. Telescoping assembly 40 may include a cylinder 22 portion of the steering column 20 slidably received by complimentary shaped housing 42. A release assembly 52, 62 may be operably attached to each of the gas springs 50, 80 to allow locking and repositioning of the steering component 30. In another embodiment, numerous other strategies may be adapted to provide the telescoping movement, tilt movement, and other ranges of motion of the assembly 10.

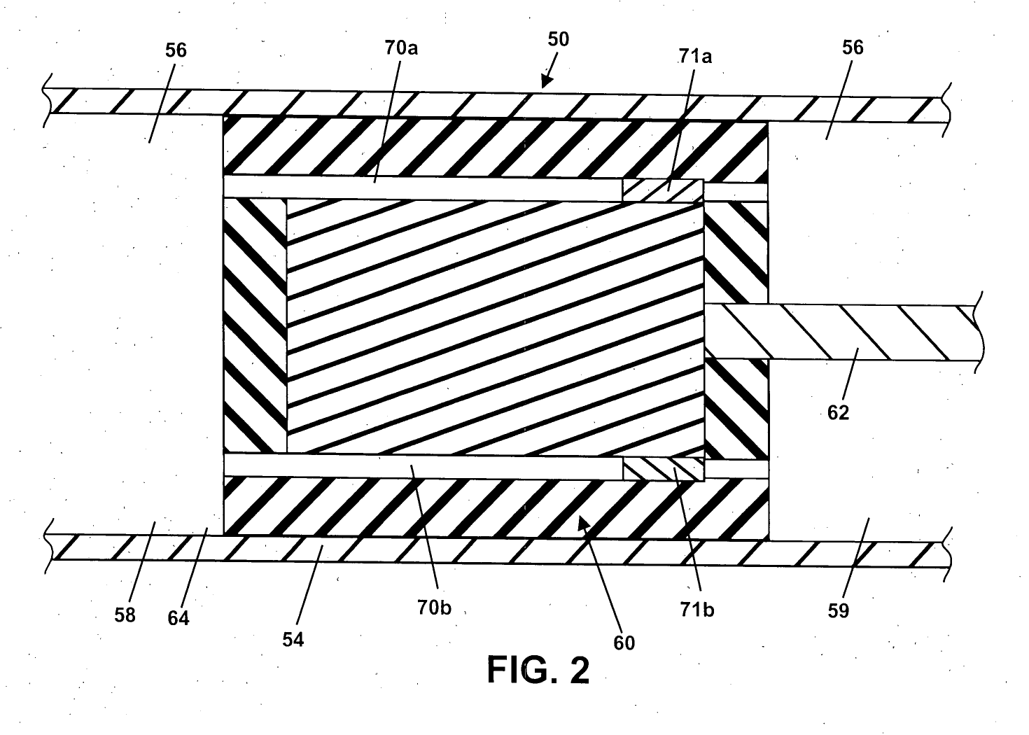

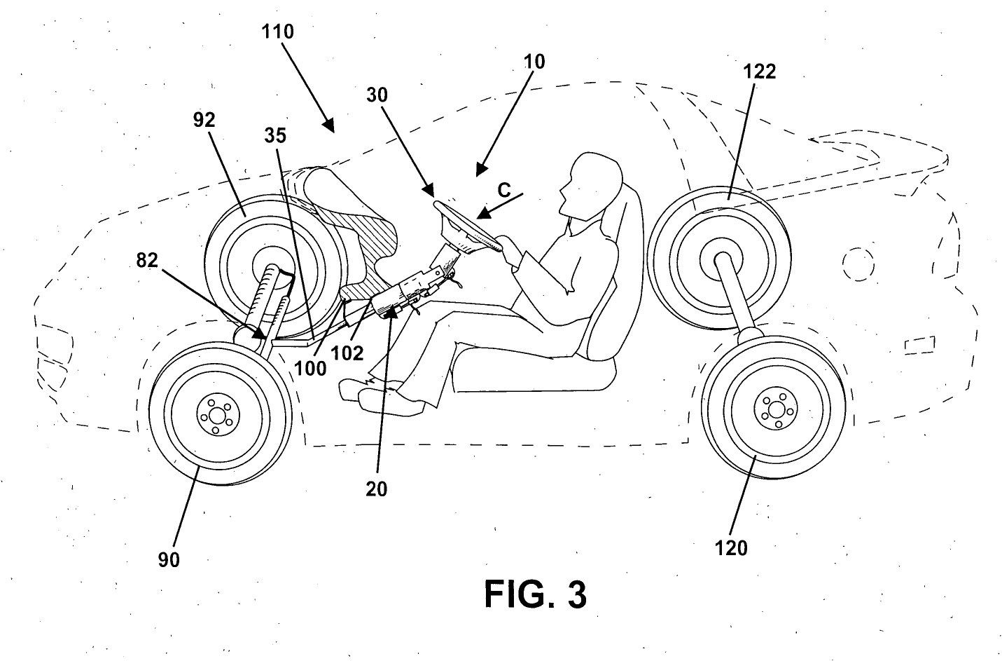

Numerous gas spring types are known in the art and may be adapted for use with the present invention. Locking gas springs are particularly well suited for use with the assembly 10 in that they provide adjustment, dampening, and an infinite number of variable locking positions. In one embodiment, as shown in detail in FIG. 2, each gas spring 50, 80 of FIG. 1 may include a similar structure including a housing 54 including with a gas 56 positioned within a first chamber 58 and a second chamber 59. Gas 56 may be an inert gas, such as nitrogen, which will preferably not react with the components of the gas spring 50, 80. A piston 60 may be slidably positioned within the housing 54. An air-tight seal may be provided between the piston 60 and an inner surface of the housing 54. Piston 60 may include a shaft 62 operably attached thereto. Movement of the shaft 62 and piston 60 displaces the gas 56 between the chambers 58, 59. Compression of the gas 56 within the first chamber 58 provides a spring force that increases with the degree of compression. A lubricant 64 may be provided within the housing 54. Lubricant 64 may be one or more oil, grease, fluid, and the like known in art. Gas springs 50, 80 may provide a plurality of locking tilt and telescoping fixed positions of the steering component 30 relative to the steering column 20. Gas springs 50, 80 may further provide an energy absorbing mechanism against a contact force exerted on the steering component 30. Specifically, a contact force exerted along arrow C (see also FIG. 3) in an axial direction on the steering component 30 may be at least partially dampened by compression of the gas 56 positioned within the first chamber 58.

In one embodiment, as piston 60 may include at least one, and in this case two, bypasses 70a, 70b. Bypasses 70a, 70b may be coupled to the release assemblies 52, 62. In the default position, the bypasses 70a, 70b are closed thereby preventing the gas 56 from flowing between the chambers 58, 59. Specifically, the bypasses 70a, 70b may be closed by actuation of valves 71a, 71b operably attached thereto. Those skilled in the art will appreciate that numerous bypasses and restrictor type check valves known in the art may be adapted for use with the present invention. Steering component 30 is locked in its current tilt and telescoping positions while the valves 71a, 71b are closed. When the release assemblies 52, 62 are triggered (e.g., pushed), the valves 71a, 71b open thereby allowing the gas 56 to flow between the chambers 58, 59. Tilt and telescoping movement of the steering column 20 and steering component 30, respectively, in modulation (i.e., a change) of gas 56 pressure between the chambers 58, 59. Specifically, movement of the steering component 30 toward the down-tilt and/or retracted positions in the present embodiment results in compression of the gas 56 within chamber 58 of the appropriate gas spring 50, 80. Manual force may be required to compress the gas 56. Movement of the steering component 30 toward the up-tilt and/or extended positions results in release of the gas 56 from chamber 58 to chamber 59 of the corresponding gas spring 50, 80. As such, the gas 56 pressure in chamber 59 is reduced which provides a force to tilt the steering component 30 upward and telescope it outward, depending on the desired adjustment. Different applications of the assembly 10 may require different bypass(es), valve(s), and piston designs. In addition, the orientation, positioning, and design of the gas springs and release assemblies may vary.

Referring to FIGS. 1A, 1B, and 1C, the gas spring 50 may be attached at a first end to the steering column 20 via a bolt (or other fastening means) positioned through an aperture 51, which is formed within a flange 24 portion of the steering column 20 and two flanking flange portions 53 of the gas spring 50. Gas spring 50 may be attached at a second end to the telescoping assembly 40 via a bolt (or other fastening means) positioned through an aperture 55, which is formed within a flange portion 44 of the telescoping assembly 40 and two flanking flange portions 57 of the gas spring 50. Gas spring 50 may be preferably attached to the steering column 20 and telescoping assembly 40 with non-rotating attachments as the telescoping movement B is linear.

Gas spring 80 may be attached to the telescoping assembly 40 at a first end to the steering column 20 via a bolt (or other fastening means) positioned through an aperture 81, which is formed within a flange portion 46 of the telescoping assembly 40 and two flanking flange portions 84 of the gas spring 80. Gas spring 80 may be attached at a second end to the steering component 30 via a bolt (or other fastening means) positioned through an aperture 86, which is formed within a flange 38 portion of the steering component 30 and two flanking flange portions 88 of the gas spring 80. Gas spring 80 may be preferably attached to the steering component 30 and telescoping assembly 40 with rotating attachments as the tilt movement A occurs about a radius.

As shown in FIG. 3, the assembly 10 may be operably attached to a vehicle 110, in this case, an automobile. Those skilled in the art will recognize that the assembly 10 may be adapted for use in other types of vehicles and applications including, but not limited to, a minivan, truck, airplane, marine vessel, and the like. In one embodiment, the assembly 10 may be operably attached to the vehicle 110 with at least one, and in this case two, brackets 100, 102, which hold the steering column 20 fast to the vehicle 110. The brackets 100, 102, may be operably attached to the vehicle 110 with one or more bolt(s), weld(s), and/or other fastening means. Shaft 35 may be coupled to a rack-and-pinion assembly 82 or other steering-type assembly and wheels 104, 106. As such, rotation of the steering component 30 results in a corresponding turning of front wheels 90, 92 thereby providing vehicle 110 steering. Optionally, the steering component 30 and shaft 35 may be coupled to rear wheels 120, 122 for vehicles including rear wheel steering.

While the embodiments of the invention disclosed herein are presently considered to be preferred, various changes and modifications can be made without departing from the spirit and scope of the invention. For example, the steering assembly configuration, and method of operating the same are not limited to any particular design or sequence. Specifically, the steering column, steering component, gas spring(s), and method of operating the same may vary without limiting the utility of the invention.

Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

1. A steering assembly comprising:
a steering column;
a steering component operably attached to the steering column, the steering component including at least one range of motion; wherein the steering component is operably attached to a shaft; and
at least one gas spring operably attached to the steering assembly wherein the at least one gas spring mediating the at least one range of motion.

2. The assembly of claim 1 wherein the at least one range of motion comprises at least one of a tilt movement and a telescoping movement.

3. The assembly of claim 2 wherein the steering component is operably attached to the steering column with a tilt assembly providing the tilt movement.

4. The assembly of claim 2 wherein the steering component is operably attached to the steering column with a telescoping assembly providing the telescoping movement.

5. The assembly of claim 1 wherein the at least one gas spring comprises:
a housing including a gas positioned within at least one chamber; and
a piston slidably positioned within the housing, the piston including a shaft operably attached thereto wherein movement of the shaft and piston displaces the gas; wherein compression of the gas provides a spring force.

6. The assembly of claim 5 further comprising a lubricant within the housing.

7. The assembly of claim 1 wherein the at least one gas spring provides a plurality of fixed positions of the steering component.

8. The assembly of claim 1 wherein the at least one gas spring provides a dampening force against a contact force exerted on the steering component.

9. The assembly of claim 1 wherein the steering assembly is operably attached to a vehicle.

10. The assembly of claim 1 further comprising a release assembly operably attached to the at least one gas spring.

11. A method of operating a steering assembly, the method comprising:
providing a steering column;
providing a steering component operably attached to the steering column; wherein the steering component is operably attached to a shaft;
providing at least one range of motion of the steering component; and
modulating a gas pressure while providing at least one range of motion.

12. The method of claim 11 wherein modulating the gas pressure comprises providing a dampening force against a contact force exerted on the steering component.

13. The method of claim 11 wherein modulating the gas pressure comprises compressing the gas.

14. The method of claim 11 wherein modulating the gas pressure comprises releasing the gas.

15. The method of claim 11 wherein the at least one range of motion comprises a tilt movement.

16. The method of claim 11 wherein the at least one range of motion comprises a telescoping movement.

17. The method of claim 11 wherein the at least one range of motion comprises a plurality of fixed positions of the steering component relative to the steering column.

18. The method of claim 11 wherein the steering assembly is operably attached to a vehicle.

19. A steering assembly comprising:
a steering column;
a steering component operably attached to the steering column; wherein the steering component is operably attached to a shaft;
means for providing at least one range of motion of the steering component; and
means for modulating a gas pressure while providing at least one range of motion.

20. The assembly of claim 19 wherein the means for modulating the gas pressure comprises means for providing a dampening force against a contact force exerted on the steering component.
